(19) United States
(12) Patent Application Publication
(10) Pub. No.: US 2010/0180573 A1
(43) Pub. Date: Jul. 22, 2010

(54) A GAS TURBINE ENGINE

(75) Inventor: Simon Mark RUSTON, Derby (GB)

Correspondence Address: MCCORMICK, PAULDING & HUBER LLP, CITY PLACE II, 185 ASYLUM STREET, HARTFORD, CT, 06103, US

(73) Assignee: ROLLS-ROYCE PLC, LONDON (GB)

(21) Appl. No.: 12/648,896

(22) Filed: Dec. 29, 2009

(30) Foreign Application Priority Data
Jan. 21, 2009 (GB) 0900921.8

(51) Int. Cl. F02K 3/02; F02C 7/20; F02C 6/04

(52) U.S. Cl. 60/226.3; 60/796; 60/785

(57) ABSTRACT

A gas turbine engine is proposed which comprises a bypass duct, a core engine, and a fluid mixing arrangement. The fluid mixing arrangement is configured to mix a bypass flow of fluid and a secondary flow of fluid, the secondary flow of fluid being drawn from the core engine. The arrangement comprises a flow duct terminating with an outlet and being arranged to direct said secondary flow through the outlet and into the bypass flow. The arrangement is characterised by the provision of a wing in the region of the outlet, said wing extending at least partially across the duct and being configured to generate lift from said secondary flow effective to produce at least one trailing vortex extending into said bypass flow. The fluid mixing arrangement can be used as a ventilation arrangement or as part of a bleed valve arrangement in the gas turbine engine.

### CROSS REFERENCE TO RELATED APPLICATION

This application is entitled to the benefit of British Patent Application No. GB 0900921.8, filed on Jan. 21, 2009.

### FIELD OF THE INVENTION

The present invention relates to a gas turbine engine. More particularly, the invention relates to a gas turbine engine provided with a fluid mixing arrangement configured to mix a bypass flow of fluid with a secondary flow of fluid drawn from the core of the engine.

### BACKGROUND OF THE INVENTION

The provision of ventilation outlets in order to vent a secondary flow of fluid into a primary flow of fluid are known in a wide range of different fields. For example, it is known to provide a ventilation outlet as part of a gas turbine engine, in order to vent a stream of hot gas from the so-called “fire zone” or core of the engine into a main gas stream, such as a relatively cool bypass flow passing through a bypass duct extending around the engine shroud.

FIG. 1 illustrates a simple vent outlet of a type proposed previously. As can be seen, the vent outlet 1, which is provided at the end of a ventilation duct, is formed flush with the surface of an engine casing 2, and may comprise one or more louvers 3 extending across the outlet. The hot stream of vent gases is indicated by arrow 4, and this is directed through the vent outlet and into a relatively cool bypass flow indicated by arrow 5, and is thus ejected from the ventilation duct into the bypass flow 5. However, a problem with this arrangement is that it is not particularly effective at mixing the hot flow of vent gas with the cool bypass flow, with the result that the hot gas impinges on the downstream surface of the engine casing and other components in that region. This leads to a “hot streak” on the engine casing and can cause significant thermal damage to the structure unless it is properly protected from the heat, which can increase the weight of the engine as well as the overall cost.

Similar problems can occur with conventional bleed valve arrangements in gas turbine engines, which are usually used to improve engine operability. In use, the heated air at high pressure passes from a compressor, through a bleed valve and via a diffuser into a main gas stream, such as the relatively cool bypass flow. The bleed valve allows this bleed flow to be actively or passively managed in sympathy with the operating characteristics of the engine at any particular instant in time. The diffuser, which typically takes the form of a so-called “pepperpot”, is used partly to attenuate noise produced within the bleed valve itself, but also to produce vortices in the flow in order to enhance mixing of the hot bleed flow with the cool bypass flow, thereby at least partly addressing the above-mentioned problems arising from the hot gases impinging on downstream parts of the engine shroud and other components. However, it has only been possible to configure these sorts of pepperpot diffusers to generate vortices in a single direction of rotation, and so they have been found to be of only limited benefit from the point of view of ensuring adequate mixture of the flows to avoid the problems of hot streaks.

It is therefore an object of the present invention to provide an improved fluid mixing arrangement in a gas turbine engine.

### SUMMARY OF THE INVENTION

According to the present invention, there is thus provided gas turbine engine includes a bypass duct, a core engine, and a fluid mixing arrangement configured to mix a bypass flow of fluid within the bypass duct and a secondary flow of fluid, the arrangement includes a flow duct terminating with an outlet and being arranged to direct said secondary flow from the core engine through the outlet and into the bypass flow, the arrangement being characterised by the provision of a wing in the region of the outlet, said wing extending at least partially across the duct and being configured to generate lift from said secondary flow effective to produce at least one trailing vortex extending into said bypass flow.

As will be appreciated, the bypass flow is a flow of relatively cool air which does not pass through the core engine, whilst the secondary flow is a flow of relatively hot gas.

The wing may be configured such that its angle of attack relative to said secondary flow is substantially constant along its span. Preferably said angle of attack does not exceed the critical angle of attack of the wing. In some embodiments, the wing can be configured such that its angle of attack relative to said secondary flow varies along its span.

The fluid mixing arrangement of the present invention may optionally comprise a wing having a substantially free wing tip, meaning that the tip of the wing is spaced from any adjacent structures such as the inner surface of the duct or outlet. This type of arrangement is thus preferably configured such that the wing generates a wing tip vortex extending into said bypass flow. This wing tip vortex can be generated in additional to other trailing vortices arising from the distribution of the lift along the span of the wing.

Alternatively, however, the arrangement may be configured such that the wing has no free wing tip, and in such an arrangement the wing is configured such that said trailing vortex arises solely from the distribution of the lift along the span of the wing.

The wing of the fluid mixing arrangement may be arranged so as not to project into said bypass flow. For example, this could be achieved by locating the wing within the flow duct, spaced slightly inwardly from the outlet, thereby isolating the wing from the bypass flow. Alternatively, however, the wing can be located substantially at the position of the outlet.

In some embodiments of the present invention the wing may be configured such that its leading edge and its trailing edge are substantially parallel to one another. Alternatively, however, the wing can be of tapered form having non-parallel leading and trailing edges. Variants are also envisaged in which the leading and/or trailing edge of the or each wing is curved.

In some arrangements, the wing has a root via which it is mounted to a louver extending substantially across said duct.

The fluid mixing apparatus may have a plurality of said wings. For example, one proposed configuration of the arrangement comprises a first wing and a second wing, said first and second wings having substantially collinear leading and/or trailing edges. An alternative arrangement has at least two pairs of wings, each said pair of wings having a first wing and a second wing, said first and second wings having substantially collinear leading and/or trailing edges.

The or each said first wing may be mounted via its root to the first side of a louver extending substantially across said duct, whilst the or each said second wing may be mounted via its root to an opposed second side of said louver. In this type of configuration, it is envisaged that the first and second wings would have substantially collinear leading and/or trailing edges.

In an alternative multi-wing arrangement of the present invention comprising at least a first wing and a second wing, said first and second wings have spaced-apart and substantially parallel leading and/or trailing edges.

One proposed configuration for the arrangement of the present invention comprises at least two said wings, arranged at opposite angles of attack (i.e. one wing arranged at a positive angle of attack, and the other arranged at a negative angle of attack) to the secondary flow.

Accordingly, such an embodiment has at least one pair of wings, the or each pair comprising a first wing and a second wing, wherein said first and second wings are arranged at opposite angles of attack to the secondary flow.

The trailing edges of said first and second wing of the or each said pair may be substantially collinear.

The first and second wings of the or each said pair are optionally substantially aligned with one another in a transverse direction across the flow duct. In such an arrangement it is envisaged that the wing tips of said first and second wings of the or each said pair would be spaced apart from one another in a transverse direction across the flow duct.

In an alternative arrangement incorporating at least one pair of said wings arranged at opposite angles of attack, the trailing edges of said first and second wings of the or each said pair are spaced apart and substantially parallel.

In this type of configuration, the first and second wings of the or each said pair may be spaced apart from one another in a longitudinal direction along the flow duct, such that the first wing is located upstream of the second wing. This arrangement allows the wing tips of said first and second wings of the or each said pair to overlap one another in a transverse direction across the flow duct. The wings can thus be positioned such that a wing top vortex produced from the upstream wing combines with a wing top vortex produced from the downstream wing sooner than would be the case with the wings transversely aligned with one another across the flow duct and with their wing tips transversely spaced apart.

It is envisaged that in some embodiments of the invention, at least a region of the flow duct immediately upstream of the wing is configured to direct the secondary flow in a direction substantially parallel to the bypass flow.

The fluid mixing arrangement of the present invention can be applied to a ventilation arrangement in which the aforementioned flow-duct takes the form of a ventilation duct, the arrangement being configured to vent said secondary flow into said bypass flow.

The fluid mixing arrangement of the present invention can also be used as part of a bleed valve arrangement. In such an arrangement, the secondary flow represents a flow of relatively hot bleed gas directed along said flow duct from the core engine and into said bypass flow.

Said flow duct may be arranged to draw said secondary flow from a compressor forming part of said core engine. Alternatively, however, the flow duct may be arranged to draw said secondary flow from a turbine section of said core engine.

So that the invention may be more readily understood, and so that further features thereof may be appreciated, embodiments of the invention will now be described, by way of example, with reference to the accompanying drawings, in which:

### BRIEF DESCRIPTION OF THE DRAWINGS

FIG. 1 is a perspective view of a prior art vent outlet;

FIG. 2 is a transverse cross-sectional view through part of a gas turbine engine provided with two bleed valve arrangements;

FIG. 3 is an enlarged, schematic view of one of the bleed valve arrangements shown in FIG. 2;

FIG. 4 is a schematic view showing a fluid mixing arrangement forming part of the bleed valve arrangement of FIG. 3, comprising a vent outlet with wings;

FIG. 5 is a view from above of the vent outlet of the arrangement illustrated in FIG. 4, showing the generation of wing top vortices from the wings;

FIGS. 6a and 6b are views corresponding generally to that of FIG. 5, but showing alternative, tapered wing planforms;

FIG. 7 is a perspective view showing a vent outlet of an alternative embodiment of the present invention, incorporating a plurality of wings;

FIG. 8 shows the vent outlet of FIG. 7 when viewed in a direction looking directly into the flow of fluid along the vent duct;

FIG. 9 is a perspective view showing a vent outlet in accordance with a further embodiment of the present invention;

FIG. 10 shows the vent outlet of FIG. 9 viewed in a direction looking directly into the flow of fluid along the ventilation duct;

FIG. 11 is a perspective view showing a vent outlet in accordance with another embodiment of the present invention;

FIG. 12 shows the vent outlet of FIG. 11 as viewed in a direction looking directly into the flow of fluid along the ventilation duct;

FIG. 13 is a schematic view showing the relationship of one pair of wings in the arrangement of FIGS. 11 and 12, viewing the wings in a direction transversely across the vent outlet;

FIG. 14 is a perspective view showing a vent outlet in accordance with a still further embodiment of the present invention;

FIG. 15 shows the vent outlet of FIG. 14 as viewed in a direction looking directly into the flow of fluid along the ventilation duct; and

FIG. 16 is an enlarged view showing the relationship between a pair of wings forming part of the arrangement of FIGS. 14 and 15, viewing the wings transversely across the vent outlet.

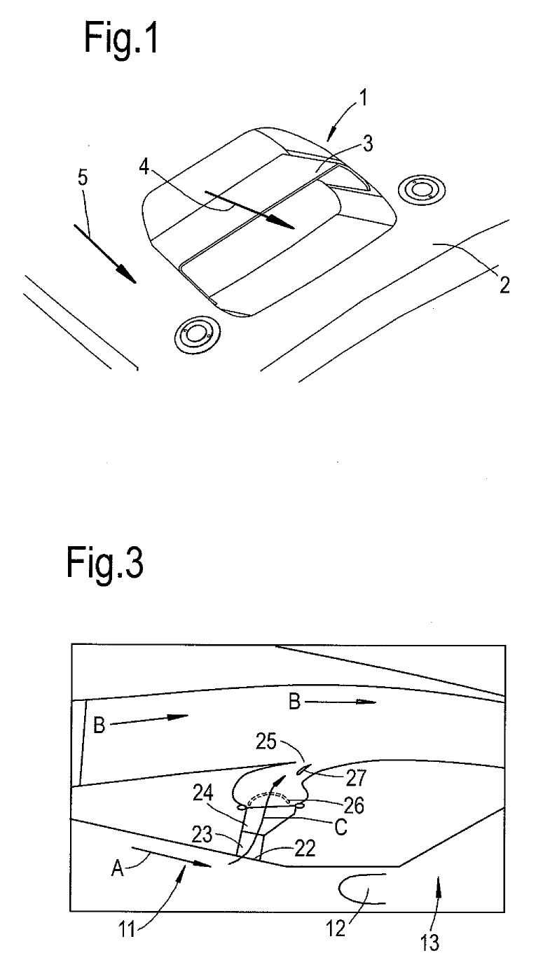

### DETAILED DESCRIPTION OF THE PREFERRED EMBODIMENTS

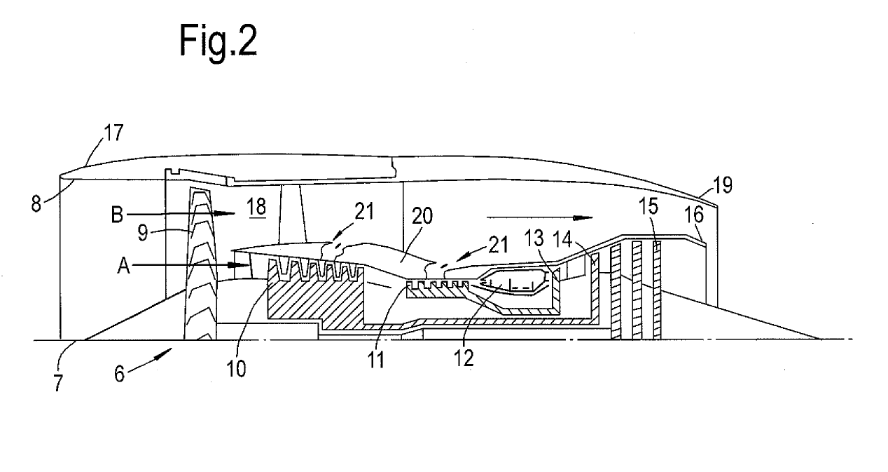

Referring now in more detail to FIG. 2, there is shown a ducted fan gas turbine engine 6 having a principle and rotational axis 7. The engine 6 has, in axial flow series; an air intake 8, a propulsive fan 9, an intermediate pressure compressor 10, a high pressure compressor 11, combustion equipment 12, a high pressure turbine 13, an intermediate pressure turbine 14, a low pressure turbine 15 and a core exhaust nozzle 16. A nacelle 17 generally surrounds the engine 6 and defines the intake 8, a bypass duct 18 and an exhaust nozzle 19. As will be appreciated, the compressors 10, 11, the combustion equipment 12, and the turbines 13, 14, 15 all form part of the so-called core engine. A casing 20 generally surrounds the aforementioned components of the core engine, and defines the inner extent of the bypass duct 18.

The gas turbine engine 6 works in a generally conventional manner such that air enters the intake 8 and is accelerated by the fan 9. Two airflows are thus produced: a core airflow A which passes into the intermediate pressure compressor 10, and a bypass airflow B which passes through the bypass duct 18 to provide propulsive thrust. The intermediate pressure compressor 10 compresses the core airflow A and delivers the resulting compressed air to the high pressure compressor 11 where further compression occurs.

The resulting compressed air exhausted from the high pressure compressor 11 is directed into the combustion equipment 12 where it is mixed with fuel and the mixture ignited. The resultant hot gases then expand through, and thereby drive, the high, intermediate and low pressure turbines 13, 14, 15 before being exhausted through the core exhaust nozzle 16 to provide additional thrust. The high, intermediate, and low pressure turbines 13, 14, 15 respectively drive the high and intermediate pressure compressors 11, 10 and the fan 9 via interconnecting shafts.

During operation of the engine 6, and particularly when changing the rotational speed of the engine at low power, it is important to ensure that the pressure ratio across each compressor 10, 11 remains below a critical working point, otherwise the engine can surge, and flow through the engine breaks down, which can cause damage to the engine.

In order to maintain a desired pressure ratio across each compressor 10, 11, bleed assemblies 21 are provided to release pressure from an upstream part of the compressors 10, 11, in a manner generally known per se. As will be seen from FIG. 2, a first bleed assembly 21 is shown in fluid communication with the intermediate pressure compressor, and a second bleed assembly is shown in fluid communication with the high pressure compressor 11.

FIG. 3 shows a single bleed assembly 21 (the bleed assembly associated with the high pressure compressor 11) in enlarged, schematic form. The bleed assembly comprises an inlet 22, a bleed valve 23, and a bleed flow duct 24 extending from the bleed valve 23 and terminating with an outlet 25 in the form of an aperture provided in the casing 20. Part of the core airflow A may be diverted through the bleed assembly 21 as airflow C, such that airflow C enters the inlet 22, passes through the bleed valve 23 and is channelled by the duct 24 to the outlet 25 through which the hot bleed flow C is then exhausted into the bypass duct 18 where it mixes with the relatively cool bypass airflow B. There will usually be an annular array of bleed valve assemblies of this general configuration arranged around the core engine casing 20.

As illustrated in FIG. 3, the bleed assembly 21 with which the present invention may be used may comprise a diffuser 26, such as a pepperpot diffuser, arranged across the duct, remote from the outlet 25. The diffuser is intended to attenuate the noise produced within the bleed valve 23. However, it should be appreciated that in contrast with conventional bleed valve arrangements incorporating such diffusers, the diffuser 26 of the arrangement illustrated in FIG. 3 is not provided at the location of the outlet 25, and so its contribution to effective mixing of the bleed flow C in the bypass flow B is thus reduced. It should be noted at this juncture that although the invention is illustrated in FIG. 3 being used in conjunction with a pepperpot diffuser 26, it can also be used with other convenient forms of noise attenuation devices, such as baffle-plates or the like.

An important feature of the bleed assembly 21 illustrated in FIG. 3 is the provision of a wing 27 extending at least partially across the duct 24 in the region of the outlet 25. As will be described in more detail below, the wing 27 is arranged to generate lift from the bleed flow C so as to produce a trailing vortex extending into the bypass flow B, thereby effectively mixing the two flows. The bypass flow B can thus be considered representative of a primary flow, and the bleed flow C can be considered representative of a secondary flow to be mixed with the primary flow.

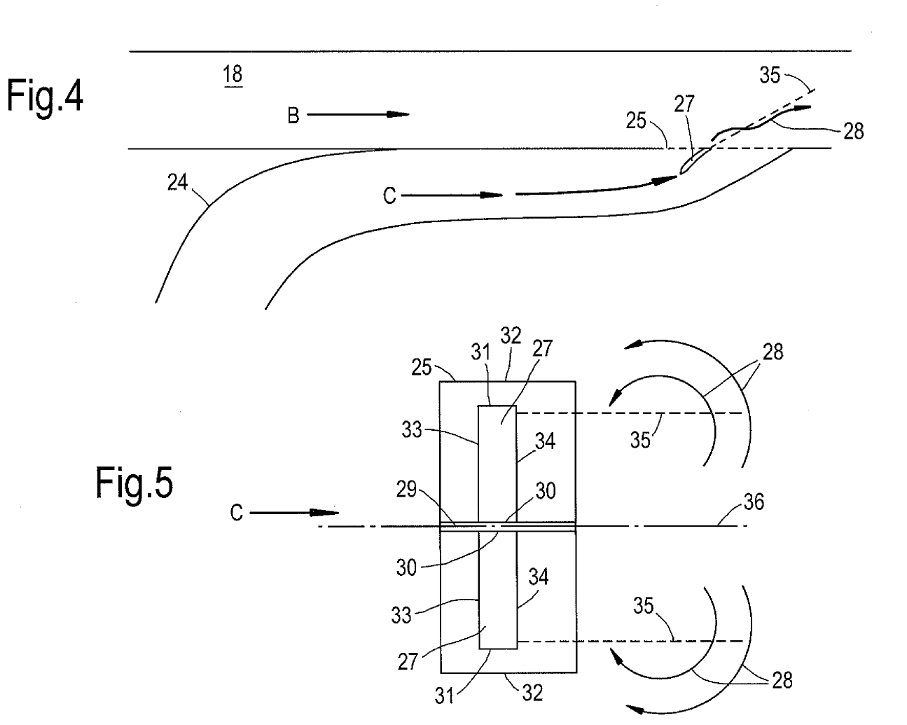

FIG. 4 shows the downstream region of the flow duct 24 in greater detail. In the arrangement illustrated, the region of the duct 24 immediately upstream of the wing 27 is configured so as to run generally parallel to the bypass duct 18, this arrangement thus being effective to direct the secondary flow represented by the bleed flow C in a direction substantially parallel to the primary flow as represented by the bypass flow B. However, it should be appreciated that in many gas turbine engines, the secondary bleed flow duct 24 is likely to be directed at an angle of between 30 and 90 degrees relative to the direction of the primary bypass flow C. An alternative to a long duct of the type illustrated in FIG. 4 is to use normal louvers arranged upstream of the wing 27, such that the secondary flow B is turned by the louvers just ahead of the wing so as to flow past the wing 27 at an appropriate angle, the wing 27 thus being presented at an appropriate angle of attack to the localised flow immediately upstream of the wing.

As illustrated in FIG. 4, the wing 27 is arranged so as to extend transversely across the downstream part of the flow duct 24, in the region of the outlet 25. However, it should be noted that the wing 27 does not project through the outlet 25 and so the wing does not extend into the bypass duct 18 and the bypass flow B flowing therethrough.

As will be appreciated from FIG. 4, the wing 27 is preferably configured so as to have an aerofoil-shaped profile and is arranged so as to lie at an angle of attack relative to the secondary bleed flow C effective to ensure that the wing generates lift from the secondary bleed flow C. As will be explained in more detail below, the wing thus produces a trailing vortex 28 which extends into the primary bypass flow B flowing along the bypass duct 18.

FIG. 5 illustrates the outlet 25 as viewed from above in the orientation illustrated in FIG. 4. As will be seen, the outlet 25 is generally rectangular in form and is arranged such that its longer dimension extends transversely relative to the direction of the secondary bleed flow C. An axially aligned central louver 29 extends across the outlet 25, the louver 29 being generally aligned with the direction of the bleed flow C. The louver 29 thus effectively divides the outlet 25 into two equal halves, each of which accommodates a respective wing 27. Each wing 27 has a root 30 via which the wing 27 is mounted to a respective side of the central louver 29. Each wing 27 thus extends outwardly from the louver 29 in the manner of a cantilever and has a respective substantially free wing tip 31. The wing tip 31 of each wing 27 is thus spaced from the immediately adjacent side edge 32 of the outlet 25 so as to define a gap therebetween.

Each wing 27 of the arrangement illustrated in FIG. 5 has a substantially straight configuration in which its leading edge 33 is substantially parallel to its trailing edge 34. Also, the two wings 27 are aligned with one another such that their respective leading edges 33 and their respective trailing edges 34 are substantially collinear. As will therefore be appreciated, both of the wings 27 are thus mounted so as to lie at substantially the same angle of attack relative to the secondary bleed flow C.

By virtue of the two wings 27 being mounted and configured so as to generate lift from the secondary bleed flow C, and by virtue of the respective wing tips 31 being substantially free and spaced from the adjacent side edges 32 of the outlet, each wing 31 produces a respective trailing vortex in the form of a wing tip vortex indicated generally at 28 in FIG. 5. Each of these wing tip vortices are created so as to rotate about a respective axis of rotation 35. As will be appreciated, and as illustrated in FIG. 5, the two vortices 28 counter-rotate relative to one another and are also spaced laterally from one another across the flow direction. As indicated in FIG. 4, the vortices 28 stretch into the bypass duct 18 and hence extend into the primary flow of bypass air B. The vortices 28 thus each entrain part of the primary flow B, drawing it inwardly towards the lateral centreline 36 of the flow duct outlet 25, thus effectively maintaining a shroud of relatively cold primary stream flow around a central region of relatively hot secondary stream flow, thereby keeping the hotter gases of the secondary bleed flow C away from the downstream surfaces and components of the engine. The vortices 28 also assist in ensuring effective mixing of the primary and secondary flows B, C.

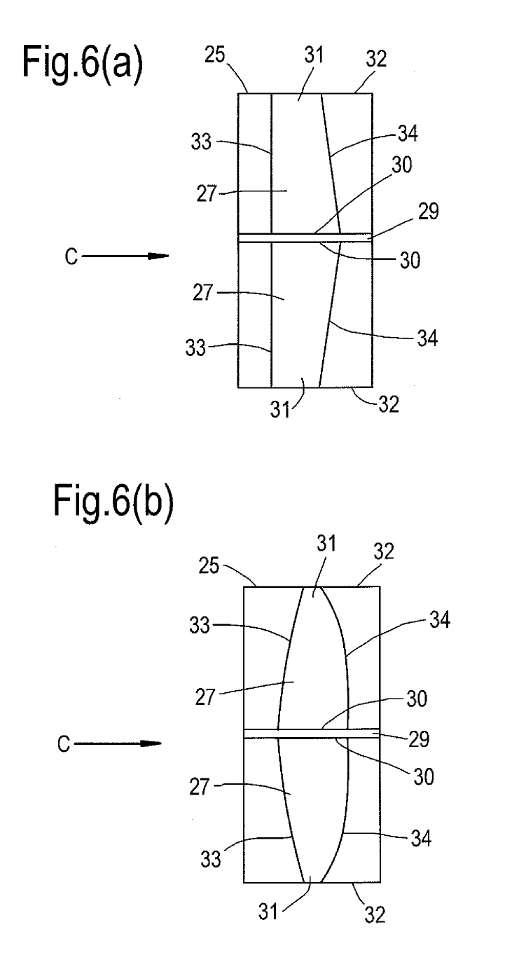

Turning now to consider FIG. 6a, there is illustrated a corresponding view of an alternative wing configuration falling within the scope of the present invention. In this arrangement, the outlet region 25 of the flow duct 4 is again provided with an axially arranged central louver 25, and a respective wing 27 extends outwardly from each side of the louver 29. However, in this arrangement it can be seen that the wings 27 each have a tapered configuration such that their respective leading edges 33 and trailing edges 34 converge in a direction moving away from the root region 30 of each wing. It should also be noted that in this arrangement, neither of the two wings 27 have a substantially fee wing tip. Instead, the two wings 27 are actually supported at both ends, namely at the root region 30, but also in the wing tip region 31, where the respective wing tips 31 are secured to the side edges 32 of the outlet aperture 25.

As will thus be appreciated, because the arrangement of FIG. 6a does not incorporate substantially free wing tips 31, it cannot generate wing tip vortices in the same manner as described above in connection with the arrangement of FIG. 5. Instead, the two wings 27 of the arrangement illustrated in FIG. 6 each produce trailing vortices solely as a result of the distribution of lift along the span of the wing 27 between the root region 30 and the wing tip region 31. Nevertheless, it is still intended that the trailing vortices will extend into the primary bypass flow B in a manner generally similar to that illustrated in FIG. 4, and so the trailing vortices will again be effective to entrain part of the primary bypass flow B within the vortices, thereby providing similar benefits to those indicated above in connection with the specific arrangement of FIG. 5.

FIG. 6b illustrates a variant of the arrangement described above and shown in FIG. 6a, in which the leading edges 33 and the trailing edges 34 are slightly curved so as to define wings 27 having a generally elliptical form. It should be appreciated, however, that it is possible to configure each wing 27 so as to have a straight leading edge and a curved trailing edge, and vice-versa.

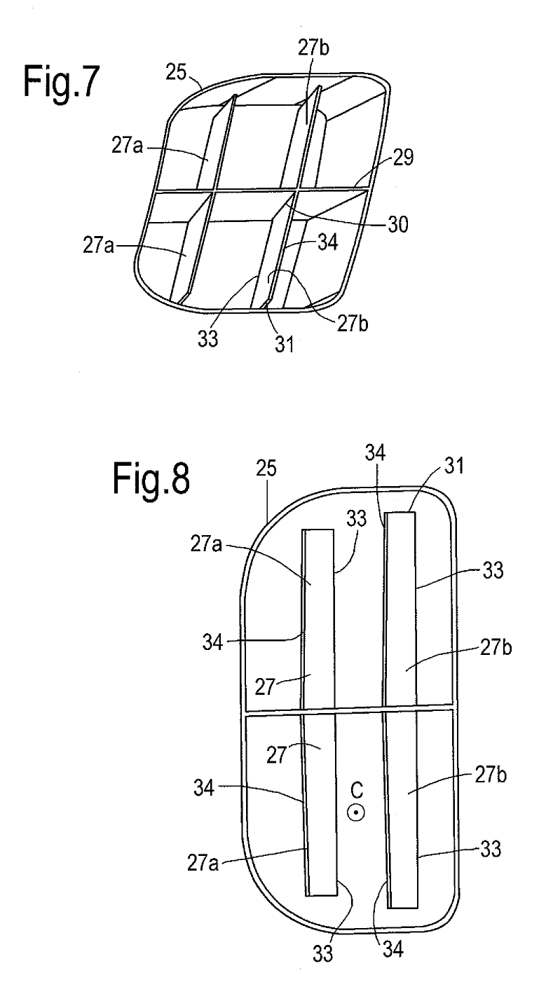

FIGS. 7 and 8 illustrate an arrangement generally similar to that of FIG. 5, but which comprises two pairs of aligned wings rather than simply a single pair as in the case of FIG. 5. FIG. 7 illustrates the wing configuration in perspective view, whereas FIG. 8 illustrates the arrangement as viewed in a direction directly into the secondary bleed flow C (the bleed flow C effectively thus flowing out of the page in a direction orthogonal to the plane of the page).

As clearly illustrated in the drawings, the four wings 27 all have a generally straight configuration with substantially parallel leading and trailing edges 33, 34. The two wings 27a of the first pair are aligned so as to have substantially collinear leading and trailing edges, whilst the two wings 27b of the second pair are similarly aligned so as to have substantially parallel leading and trailing edges. The two pairs are spaced apart from one another so that the wings 27a of the first pair are substantially parallel to the slightly longer wings 27b of the second pair. All four of the wings are arranged at substantially equal angles of attack relative to the secondary bleed flow C, and each of the four wings also has a substantially free wing tip 31 in the same general manner as in the arrangement of FIG. 5. As will thus be appreciated, the arrangement of FIGS. 7 and 8 is thus effective to generate two pairs of trailing wing tip vortices in a generally similar manner to the way in which the arrangement of FIG. 5 generates a single pair of trailing wing tip vortices. Each of the wing tip vortices produced by the arrangement of FIGS. 7 and 8 is thus effective to entrain part of the primary bypass flow B.

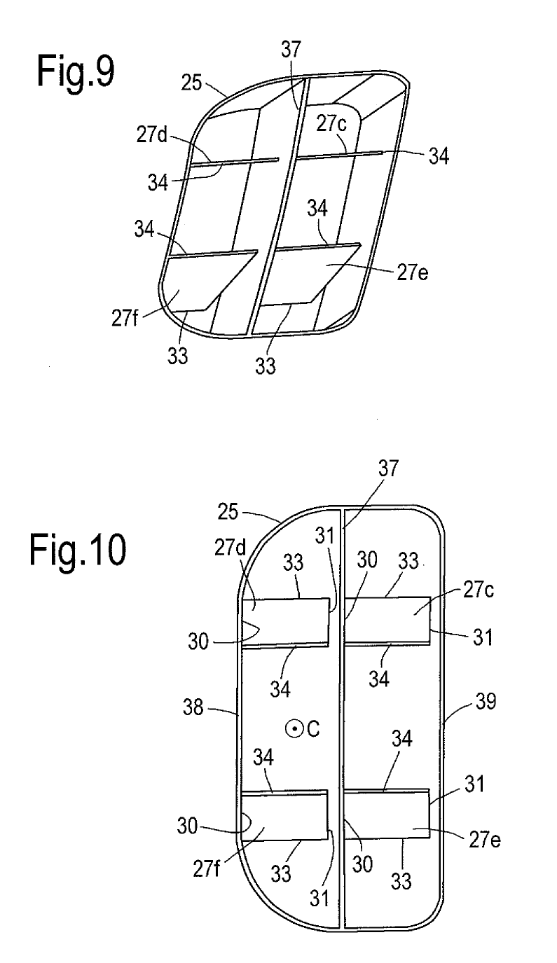

As will be appreciated, the arrangements of FIGS. 5 to 8 described above each comprise wings arranged so as to extend at least partially across the flow duct 24 in a generally transverse direction. In contrast, the arrangement illustrated in FIGS. 9 and 10 comprises four wings, each of which is arranged so as to extend partially across the flow duct 24 in an axial manner. As illustrated in FIGS. 9 and 10, in this arrangement, the outlet 25 of the flow duct is provided with a transverse louver 37 extending across the outlet 27 so as to divide the outlet into two approximately equal halves. The four wings are arranged into two pairs, namely a first pair comprising a first wing 27c and a second wing 27d, and a second pair comprising a first wing 27e and a second wing 27f. The two wings of each of the aforementioned pairs are generally aligned with one another so as to have substantially collinear leading edges 33 and substantially collinear trailing edges 34. However, the two pairs of wings are arranged so as to lie at opposite angles of attack relative to the secondary bleed flow C flowing along the flow duct 24 and out through the outlet 25. For example, in the arrangement illustrated in FIGS. 9 and 10, the first and second wings 27c, 27d of the first pair can be considered to lie at a positive angle of attack relative to the flow C, whereas the first and second wings 27e, 27f of the second pair lie at an opposite, negative, angle of attack relative to the flow C. With the two pairs of wings being transversely spaced apart across the outlet 25, with their trailing edges 34 being spaced apart by a smaller distance than their leading edges 33, the wings are thus arranged to form a constriction to the flow C passing between the two pairs of wings.

Referring in particular to FIG. 10, it will be seen that the first wing 27c, 27e of each aforementioned wing pairs is mounted via its respective root portion 30 to one side of the transverse louver 37, whilst the second wing 27d, 27f of each wing pair is mounted by its respective root portion 30 to a side wall 38 of the flow duct 24 in the region of the outlet 25. Each of the four wings has a substantially free wing tip 31. In the case of the first wing 27c, 27e of each wing pair, the wing tip 31 is spaced from the adjacent side wall 39 of the duct, and in the case of the second wing 27d, 27f of each wing pair, the wing tip 31 is spaced from the transverse louver 37. In this manner, each wing tip 31 is configured to produce a respective wing tip vortex, and by virtue of the arrangement of the four wings in the region of the outlet 25, the four respective vortices will each extend into the primary bypass flow B in a manner generally similar to that described above and illustrated schematically in FIG. 4.

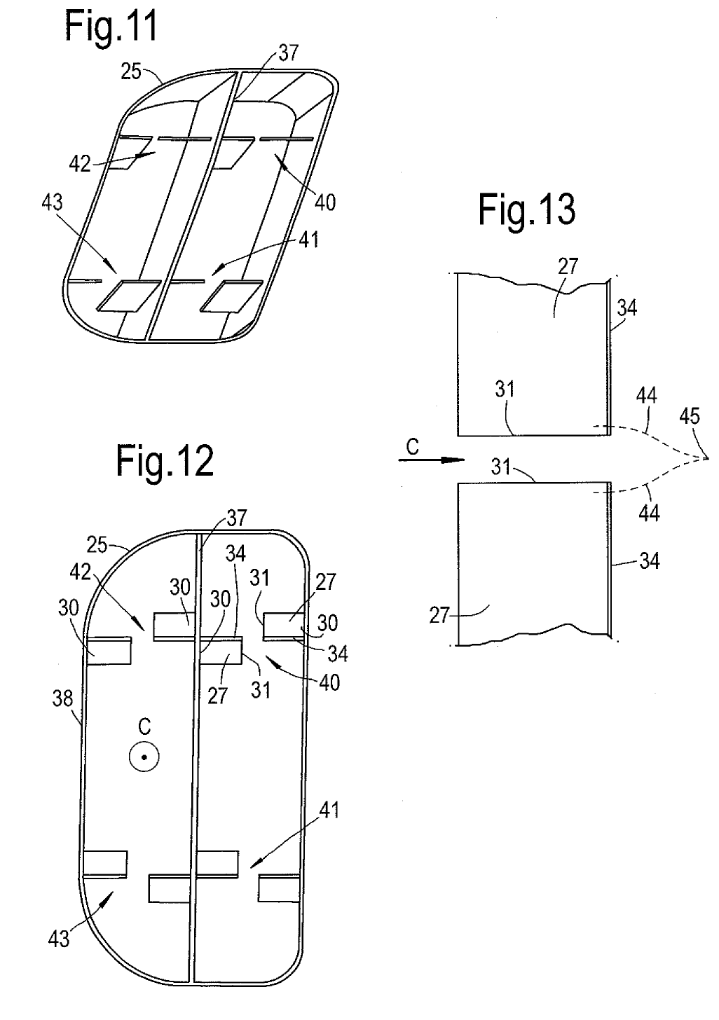

FIGS. 11 and 12 illustrate another embodiment having a plurality of wings, the wings being provided within the outlet region of a flow duct having a transverse louver 37 extending thereacross. In this arrangement, there are eight wings provided in groupings of four pairs. The first pair is indicated generally at 40, the second pair is indicated generally at 41, the third pair is indicated generally at 42 and the fourth pair is indicated generally at 43.

Focussing initially on the first pair of wings indicated generally at 40, it can be seen that the two wings 27 and arranged so as to lie at opposite angles of attack relative to the secondary bleed flow C. One of the wings is mounted via its root region 30 to the transverse louver 37, whilst the other wing is mounted via its root portion 30 to the adjacent side wall 39 of the duct in the region of the outlet 25. Both of the wings in the first pair 40 are thus mounted in the manner of a cantilever and extend generally towards one another from their root portions 30 terminating with respective wing tips 31, the two wing tips being spaced apart from one another. As illustrated most clearly in FIG. 12, the trailing edges 34 of the two wings making up the first pair 40 are substantially collinear.

The second pair of wings 41 is spaced from the first pair 40 and has a generally similar configuration, although it should be appreciated that the second pair 41 is arranged as a mirror image of the first pair across the duct centreline. Thus, it can be seen that whilst the upstream wing of the first pair 40 has a positive angle of attack relative to the secondary flow B, the upstream wing of the second pair 41 has a negative angle of attack. Similarly the downstream wing of the first pair 40 has a negative angle of attack, whilst the downstream wing of the second pair 41 has a positive angle of attack.

The third pair of wings 42 has a generally identical configuration to the first pair 40 but is arranged on the opposite side of the louver 37 so that one of its wings is mounted to the opposite side of the louver via its root portion 30 and such that its other wing is mounted to the opposite side wall 38 of the flow duct via its root portion. The fourth pair of wings is spaced from the third pair so as to be generally aligned with the second pair, and has a configuration substantially identical to that of the second pair of wings 41. The third and fourth pairs of wings 42, 43 are thus mirror symmetrical about a line transverse centreline of the duct 24.

As will therefore be appreciated, each of the eight wings in the arrangement of FIGS. 11 and 12 has a respective free wing tip 31 spaced from the wing tip of the neighbouring wing and so each of the eight wing tips generates a respective wing tip vortex.

FIG. 13 shows the wing tip regions of the two wings of a single wing tip pair of the arrangement illustrated in FIG. 12, in a direction looking transversely across the duct outlet 25. As is illustrated, the two wings of each pair are substantially aligned with one another such that their trailing edges 34 are substantially collinear. The wing tip vortices produced by each wing tip 31 are illustrated schematically at 44, and it is to be appreciated that in this arrangement, the two wing tip vortices are initially spaced from one another, but converge at a point 45 which is located downstream of the two trailing edges 34.

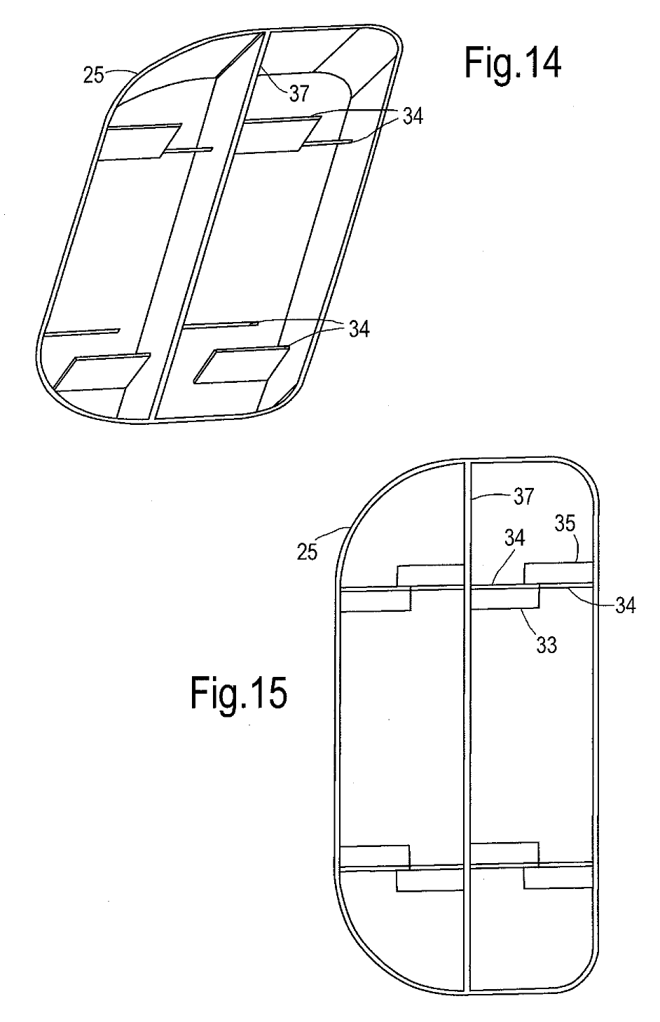

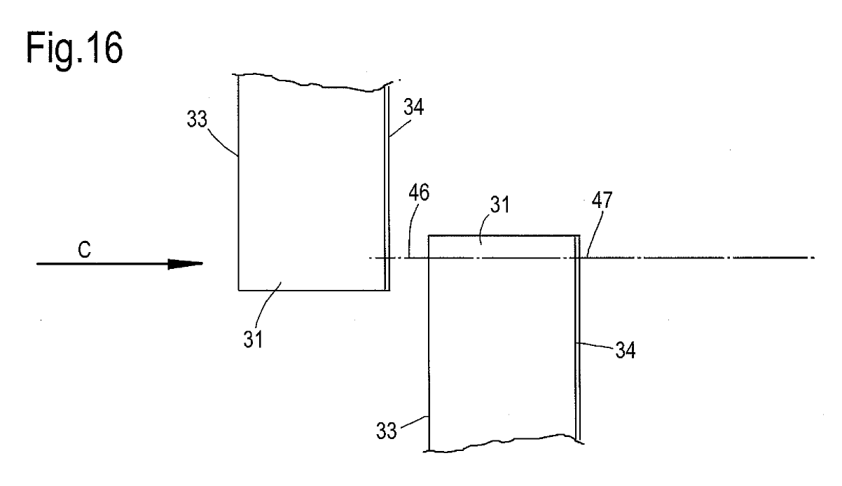

FIGS. 14, 15 and 16 correspond generally to the views illustrated in FIGS. 11, 12 and 13, but illustrate a modified embodiment in which the two wings 27 of each wing pair are spaced apart from one another in a longitudinal direction along the flow duct such that one of the wings in each pair is located upstream of the second wing in each pair (relative to the secondary bleed flow C). This is illustrated most clearly in FIG. 16, from which it can also be seen that the wings of each pair are somewhat longer than in the arrangement described above with reference to FIGS. 11 and 13, such that the wing tips 31 overlap one another in a transverse direction across the flow duct. This overlapping relationship is preferably arranged such that the wing tip vortex 46 generated by the upstream wing is substantially aligned with the wing tip vortex 47 generated by the downstream wing, so that the two vortices combine in the region of the outlet 25 rather than at a downstream position as in the case of the arrangement described above and illustrated in FIGS. 11 to 13.

By using a wing mixing arrangement in accordance with the present invention across the outlet to a bleed-flow duct in a gas turbine engine, instead of a conventional pepperpot configured for fluid mixing, the outlet can be reduced in size without reducing the effective vent area. This has the benefit of necessitating a smaller discontinuity in the wall of the bypass duct into which the bleed-flow duct vents, which is important as it means less noise attenuation material is sacrificed from the wall of the bypass duct, resulting in improved noise attenuation characteristics.

Whilst the invention has been described above with specific reference to arrangements incorporating substantially rectangular flow outlets 25, it is to be appreciated that in variants of the invention, the vent outlet 25 may have a different form, in order to optimise the profile of the outlet for a desired vortex generation, or flow characteristic.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

What is claimed is:

1. A gas turbine engine comprising
a bypass duct,
a core engine,
a fluid mixing arrangement configured to mix a bypass flow of fluid within the bypass duct and a secondary flow of fluid,
the arrangement having a flow duct terminating with an outlet and being arranged to direct said secondary flow from the core engine through the outlet and into the bypass flow, f a wing in the region of the outlet, said wing extending at least partially across the duct and being configured to generate lift from said secondary flow effective to produce at least one trailing vortex extending into said bypass flow, wherein the wing has a substantially free wing tip and is configured generate the wing tip vortex.

2. A gas turbine engine according to claim 1, further comprising a wing configured such that its angle of attack relative to said secondary flow is substantially constant along its span.

3. A gas turbine engine according to claim 2, wherein said angle of attack does not exceed the critical angle of attack of the wing.

4. A gas turbine engine according to claim 1, further comprising a wing configured such that its angle of attack relative to said secondary flow varies along its span.

5. A gas turbine engine according to claim 1, wherein said wing is arranged so as not to project into said bypass flow.

6. A gas turbine engine according to claim 1, wherein said wing is located substantially at the position of the outlet.

7. A gas turbine engine according to claim 1, further comprising a wing having a leading edge and a trailing edge which are substantially parallel to one another.

8. A gas turbine engine according to claim 1 further comprising a wing of tapered form.

9. A gas turbine engine according to claim 8, wherein the leading and/or trailing edge of the wing is curved.

10. A gas turbine engine according to claim 1 wherein said wing has a root via which the wing is mounted to a louver extending substantially across said duct.

11. A gas turbine engine according to claim 1 further comprising a plurality of said wings.

12. A gas turbine engine according to claim 11, further comprising a first wing and a second wing, said first and second wings having substantially collinear leading and/or trailing edges.

13. A gas turbine engine according to claim 1, further comprising at least two pairs of wings, each said pair of wings comprising a first wing and a second wing, said first and second wings having substantially collinear leading and/or trailing edges.

14. A gas turbine engine according to claim 12, wherein the or each said first wing is mounted via its root to a first side of said louver, and wherein the or each said second wing is mounted via its root to an opposed second side of said louver.

15. A gas turbine engine according to claim 11, further comprising at least a first wing and a second wing, said first and second wings having spaced-apart and substantially parallel leading and/or trailing edges.

16. A gas turbine engine according to claim 11, further comprising at least one pair of wings, the or each pair comprising a first wing and a second wing, wherein said first and second wings are arranged at opposite angles of attack to the secondary flow.

17. A gas turbine engine according to claim 1, wherein said flow duct takes the form of a ventilation duct configured to vent said secondary flow into said bypass flow.

18. A gas turbine engine according to claim 1 further comprising a bleed valve arrangement, wherein said secondary flow is a flow of bleed gas directed along said flow duct from said core engine and into said bypass flow.

19. A gas turbine engine according to claim 1, wherein said flow duct is arranged to draw said secondary flow from a compressor forming part of the core engine.

20. A gas turbine engine according to claim 1, wherein said flow duct is arranged to draw said secondary flow from a turbine forming part of said core engine.
